(19) United States
(12) Patent Application Publication
(10) Pub. No.: US 2002/0190002 A1
(43) Pub. Date: Dec. 19, 2002

(54) Chemical purification cartridge

(76) Inventors: Karl J. Urquhart, McKinney, TX (US); Joe G. Hoffman, Dallas, TX (US); David Snyder, Princeton, TX (US); Vinod Raghavan, Dallas, TX (US); Mary D. Havlicek, Richardson, TX (US); John Geurian, Garland, TX (US)

Correspondence Address: E. Joseph Gess, Esq., BURNS, DOANE, SWECKER & MATHIS, L.L.P., P.O. Box 1404, Alexandria, VA, 22313-1404, US

(21) Appl. No.: 09/824,771

(22) Filed: Apr. 4, 2001

(51) Int. Cl. B01D 15/00

(52) U.S. Cl. 210/683; 210/284

(57) ABSTRACT

Provided are cartridges, apparatuses and methods for purifying a liquid chemical. The cartridges include a conduit connected to receive a flow of a chemical to be purified. A packed section in the conduit comprises a purification material. The ratio of the length of the packed section to the inside diameter of the conduit is from about 8:1 to about 200:1. The flow of the chemical to be purified contacts the purification material, thereby producing a flow of a purified chemical. This invention has particular applicability to the semiconductor manufacturing industry.

### BACKGROUND OF THE INVENTION

1. Field of the Invention

The present invention relates to cartridges and apparatuses for purifying a liquid chemical. The present invention also relates to methods for purifying a liquid chemical. The invention has particular applicability in the semiconductor manufacturing industry.

2. Description of the Related Art

In the semiconductor manufacturing industry, a major concern at every stage in the manufacturing process is contamination. Control of contamination is important to product quality, and an extremely high level of cleanliness and purity in the manufacturing environment is typically required to obtain acceptable product yield while maintaining profitability. Accordingly, many of the steps in modern integrated circuit (IC) manufacturing are dedicated to cleaning the semiconductor wafers being treated. Such cleanup steps are implemented to remove, for example, organic contaminants, metallic contaminants, photoresist (or inorganic residues thereof), byproducts of etching and native oxides.

A significant source of contamination is the process chemicals themselves, which contain various impurities. Process chemicals are frequently used in the cleanup steps of the manufacturing process which help maintain product quality. Contamination present in such process chemicals is undesirable.

In wet processing steps, a liquid reagent can be used for a variety of purposes including, for example, the etching of silicon dioxide, silicon nitride or silicon. The liquid reagent can also be used for removing native oxide layers, organic materials, trace organic/inorganic contaminants or metals. The purity of the liquid chemicals typically affects the yield and the reliability of the devices being formed. In liquid cleanup steps that are directly followed by high-temperature processes, contaminants on the wafer surface are typically driven and/or diffused into the wafer.

A major concern for wet process chemicals is ionic contamination. IC devices generally include only a few dopant species such as, for example, boron, arsenic, phosphorus and antimony, to form the p-type and n-type doped regions of the devices. However, contaminants present in the chemicals used in wet processing steps can also act as electrically active dopants and have deleterious effects on the IC devices. Thus, the presence of these contaminants is highly undesirable.

It is therefore apparent that liquid chemicals for treating semiconductor wafers should have extremely low concentrations of impurities including, for example, metal ions. Preferably, the total metal content should be less than 300 ppt (parts per trillion), and preferably less than 10 ppt for any single metal.

Hydrogen peroxide (H₂O₂) is commonly used in wet cleanup process steps in the manufacturing of a semiconductor wafer. For example, the widely used “piranha” cleanup solution typically includes hydrogen peroxide and sulfuric acid (H₂SO₄) in a ratio of about 30:70. In addition, the widely used “RCA” cleanup procedure typically has three-stages, two of which can include the use of hydrogen peroxide.

Hydrogen peroxide is generally not easily purified. For example, the decomposition of hydrogen peroxide can be exothermic, temperature sensitive, and/or catalyzed by various contaminants. Hydrogen peroxide is also a powerful oxidant. In addition, certain materials used to purify hydrogen peroxide can also contribute to its decomposition.

Conventional columns that are used for purifying hydrogen peroxide typically present safety concerns. For example, contacting hydrogen peroxide with a purification material, such as an ion exchange bed, to remove ionic contaminants therefrom can evolve oxygen. The generation of oxygen typically results in the accumulation of pressure. Conventional columns containing a purification material are typically made of rigid and inflexible material. Such material is typically unable to expand, tear or otherwise compensate for the accumulating internal pressure. If not properly maintained, such columns can explode when under excessive amounts of pressure, resulting in equipment damage and constituting a safety hazard. Thus, careful monitoring of the pressure within the column is typically required.

Conventional hydrogen peroxide purification columns typically are periodically shut down for maintenance purposes. The replacement of the purification material inside a column generally requires the column to be shut down, for example, for about two days. This decreases the productivity of the column. Furthermore, the conventional column typically employs gravity flow of the chemical therethrough, thereby requiring the column to be positioned vertically. This can place limits on where the column can be installed. The use of gravity flow can also limit the flow rate of the chemical through the column, for example, to less than 1 lpm (liter per minute).

The flow characteristics of the hydrogen peroxide through the purification material provided by current purification columns can present additional disadvantages. For example, the flow characteristics can cause sulfates, nitrates and/or chlorides present in the purification material to be released into the hydrogen peroxide, thereby contaminating the purified product. For example, hydrogen peroxide purified by a current column typically contains from about 15 to 22 ppb of each of sulfates, nitrates and/or chlorides. The flow characteristics can also cause prolonged contact between the hydrogen peroxide and the purification material, which in turn can produce an excessive amount of oxygen gas. As discussed above, the production of oxygen gas typically generates pressure within the column and can cause equipment damage and present a safety hazard.

Current on-site chemical purification systems are typically expensive. For example, the equipment used in such systems can cost upwards of one million dollars. Maintenance of the equipment can incur additional costs. Further, the equipment typically occupies a relatively large space, thereby limiting the usable area in a semiconductor manufacturing facility.

Consequently, to meet the requirements of the semiconductor processing industry and to overcome the disadvantages of the related art, it is an object of the present invention to provide cartridges, apparatuses and methods for purifying a liquid chemical that can conspicuously ameliorate or eliminate the above-described disadvantages of the related art.

Other objects and aspects of the present invention will become apparent to one of ordinary skill in the art upon review of the specification, drawings and claims appended hereto.

### SUMMARY OF THE INVENTION

The foregoing objectives are met by the present invention. According to a first aspect of the present invention, a cartridge for purifying a liquid chemical is provided. The cartridge includes:

(a) a conduit connected to receive a flow of a chemical to be purified; and

(b) a packed section in the conduit comprising a purification material, wherein the ratio of the length of the packed section to the inside diameter of the conduit is from about 8:1 to about 200:1, and wherein the flow of the chemical to be purified contacts the purification material, thereby producing a flow of a purified chemical.

According to another aspect of the present invention, a method for purifying a liquid chemical is provided. The method includes introducing the flow of the chemical to be purified to the cartridge described above.

According to another aspect of the present invention, an apparatus for purifying a liquid chemical is provided. The apparatus includes:

(a) a chemical source for providing a main flow of the chemical to be purified; and

(b) a plurality of the cartridges described above, wherein the plurality of the cartridges is connected to receive the main flow of the chemical to be purified.

According to another aspect of the present invention, a method for purifying a liquid chemical is provided. The method includes introducing the main flow of the chemical to be purified to the plurality of the cartridges of the apparatus described above.

According to a further aspect of the present invention, a detachable fitting for connection to a fluid transport line is provided. The fitting includes:

(a) a conduit having an inlet end for receiving a flow of fluid from a fluid-providing line and an outlet end for introducing the flow of fluid to a fluid-receiving line;

(b) a first connection device arranged to removably connect the inlet end of the conduit to the fluid-providing line;

(c) a second connection device arranged to removably connect the outlet end of the conduit to the fluid-receiving line; and

(d) a device disposed inside the conduit, wherein the flow of fluid contacts the device.

### BRIEF DESCRIPTION OF THE DRAWINGS

The objects and advantages of the invention will become apparent from the following detailed description of the preferred embodiments thereof, in connection with the accompanying drawings, in which like features are designated by like reference numerals, and in which:

FIG. 1A illustrates a side view of an exemplary cartridge for purifying a liquid chemical, according to one aspect of the invention;

FIG. 1B illustrates a side view of an end member of the exemplary cartridge shown in FIG. 1A, according to another aspect of the invention;

FIG. 1C illustrates an exploded side view of an end member of the exemplary cartridge shown in FIG. 1A, according to another aspect of the invention;

FIG. 2 illustrates a block flow diagram of an exemplary apparatus for purifying a liquid chemical, according to another aspect of the invention;

FIG. 3 illustrates a block flow diagram of an exemplary apparatus for purifying a liquid chemical according to another aspect of the invention, wherein the apparatus is connected to receive a chemical to be purified from a mobile source;

FIG. 4 illustrates a block flow diagram of an exemplary apparatus for purifying a liquid chemical according to another aspect of the invention, wherein the apparatus is connected to receive a liquid chemical to be purified from a mobile source and to pass a purified chemical to a day tank;

FIG. 5 illustrates a block flow diagram of an exemplary apparatus for purifying a liquid chemical according to another aspect of the invention, wherein the apparatus is connected to receive a liquid chemical to be purified from a chemical dispensing unit (CDU) and to pass a purified chemical to various points of use; and

FIG. 6 illustrates a block flow diagram of an exemplary apparatus for purifying a liquid chemical according to a further aspect of the invention, wherein the apparatus is connected to receive a liquid chemical to be purified from a bulk storage tank and to store a purified chemical in a plurality of storage tanks.

### DETAILED DESCRIPTION OF THE PREFERRED EMBODIMENTS OF THE INVENTION

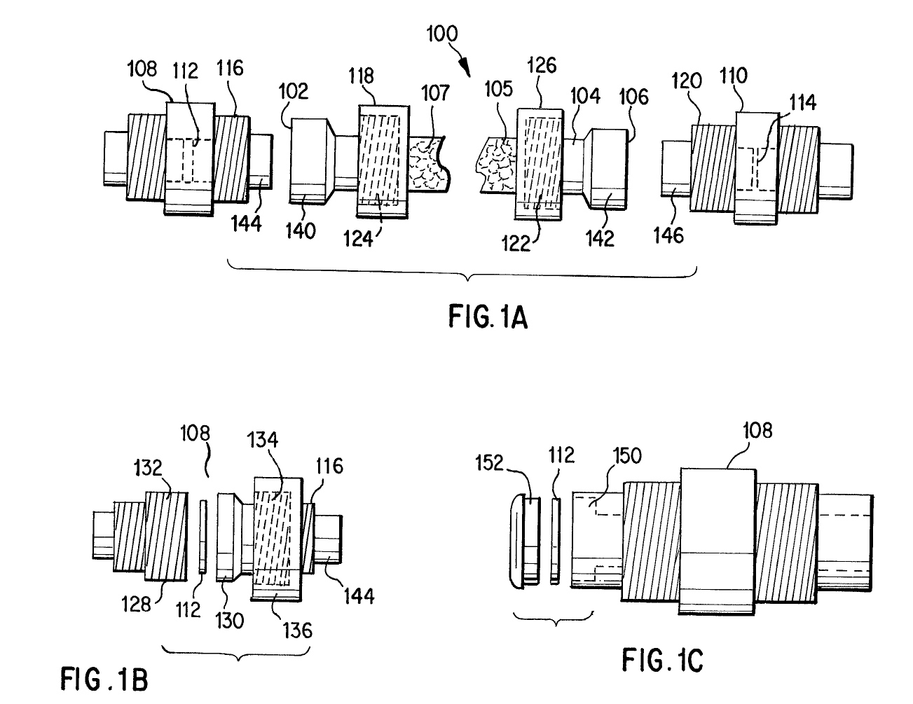

The invention will now be described with reference to FIG. 1A, which illustrates a cartridge 100 in accordance with an exemplary aspect of the present invention. The cartridge 100 purifies a liquid chemical. The cartridge 100 can generate a flow therethrough having flow characteristics which are effective for increasing the purity level of the chemical passed therethrough. The purified liquid chemical is preferably suitable for use in a semiconductor fabrication process.

The liquid chemical to be purified can be any chemical that is capable of being purified through contact with a purification material. For example, the chemical to be purified can be a hydrogen peroxide solution, hydrofluoric acid, hydrochloric acid, ammonium hydroxide solution, acetone, isopropyl alcohol or water. Combinations of chemicals can also be purified such as, for example, mixtures of acetic and hydrofluoric acid, ammonium hydroxide and hydrogen peroxide, or hydrochloric acid and hydrogen peroxide. Other chemicals and chemical mixtures used in the semiconductor fabrication industry can also be purified.

In a preferred embodiment, the chemical to be purified comprises a hydrogen peroxide solution. For example, given a hydrogen peroxide feed solution containing from about 1 to about 10 ppb metallic impurities per contaminant and from about 20 to about 30 ppm total organic carbon impurities, the cartridge 100 can typically provide a purified hydrogen peroxide solution having a cationic concentration of less than or equal to about 1 ppb per cationic contaminant, an anionic concentration of less than or equal to about 10 ppb per anionic contaminant, and a total organic carbon contaminant concentration of less than or equal to about 20 ppm.

The cartridge 100 includes a conduit 104 having an inlet 102 and an outlet 106. The inlet 102 is connected to receive a flow of the chemical to be purified. The flow of the chemical to be purified flows through the conduit 104. The conduit 104 is partially or entirely packed with a purification material 105, preferably entirely packed with the purification material 105. The purification material 105 disposed in the conduit 104 forms a packed section 107 of the conduit 104. The density of the packed purification material 105 will depend, for example, on the type of purification material employed. The flow of the chemical to be purified contacts the purification material 105 disposed in the conduit 104, thereby producing a flow of a purified chemical. The flow of the purified chemical is removed from the conduit 104 via the outlet 106.

The dimensions of the cartridge 100 can depend on several factors including, for example, the desired flow rate of the chemical through the cartridge 100, the characteristics of the chemical to be purified and/or the characteristics of the purification material 105 that is employed. The dimensions of the cartridge 100 should be sufficient to accommodate the packed section 107 of the conduit 104. The ratio of the length of the packed section 107 of the conduit 104 to the inside diameter of the conduit 104 is typically from about 8:1 to about 200:1, preferably from about 15:1 to about 50:1, and more preferably about 25:1. The inside diameter of the conduit 104 is typically from about 0.25 to about 2 inches (about 0.64 to about 5.08 cm), preferably from about 0.75 to about 1.25 inches (about 1.91 to about 3.18 cm), and more preferably about 1 inch (about 2.54 cm). The length of the packed section 107 of the conduit 104 is typically from about 16 to about 50 inches (about 40.64 to about 127 cm), preferably from about 18.75 to about 37.5 inches (about 47.63 to about 95.25 cm), and more preferably about 25 inches (about 63.5 cm).

The shape of the conduit 104 can take various forms, and typically depends on the flow characteristics imparted by the shape, the compactness of the shape and/or the cost of manufacturing the conduit 104 with such a shape. Generally, a preferred conduit 104 has a compact shape and is relatively inexpensive to manufacture. For example, the conduit 104 can comprise a linear or spiral tube. The conduit 104 preferably has a circular cross-sectional profile. In an alternative embodiment, the conduit 104 can have a cross-sectional profile of some other shape such as, for example, a non-circular ellipse.

The flow of the chemical to be purified contacts the purification material 105 disposed in the conduit 104, thereby reducing the amount of contaminant(s) present in the chemical. The contaminant(s) reduced typically depends at least on the type of purification material 105 that is employed. For example, in the case of hydrogen peroxide purification, at least one purification material can be employed that decreases the amount of an organic contaminant, an anionic contaminant, a cationic contaminant and/or combinations thereof, in the chemical to be purified.

The purification material 105 includes at least one type of material that is capable of purifying the chemical upon contact therewith. In a preferred embodiment, the purification material 105 comprises multiple types of purification material. The multiple types of purification material can be mixed to form a mixture, such as a homogeneous mixture, or the multiple types of purification material can be separately maintained in the conduit 104. For example, a material that allows the flow of the chemical therethrough but prevents the flow of the multiple types of purification material therethrough can be used to separate the multiple types of purification material. In a preferred embodiment, at least one separator such as, for example, a screen, can be disposed in the cartridge 100 to separate the multiple types of purification material. It is noted however, that such a separator need not be employed, even where more than one purification material is used.

The purification material 105 can be periodically replaced to maintain the purification efficiency of the cartridge 100. The usable lifetime of the purification material 105 will depend on several factors including, for example, the type and/or amount of purification material 105 used, the dimensions of the cartridge 100, the purity of the chemical to be purified, and/or the flowrate of the chemical to be purified. For example, the useable lifetime of a mixture of DOWEX MONOSPHERE 550 CC NG OH anion resin and DOWEX MONOSPHERE C—650 NG H cation resin H form used for the purification of hydrogen peroxide was measured to be at least about 7000 BV (bed volumes). The usable lifetime of the purification material 105 preferably can be determined beforehand and the purification material 105 can be periodically replaced based on the predetermined usable lifetime. Alternatively, the purification material 105 can be replaced when the purity level of the purified chemical diminishes to a predetermined level.

The cartridge 100 is typically connected to a chemical source conduit to receive a flow of the chemical to be purified from a chemical source. The chemical source can include, for example, a bulk storage tank or a chemical delivery vehicle containing the chemical to be purified. The cartridge 100 is typically also connected to a product conduit to remove the flow of the purified chemical therefrom. The product conduit can introduce the purified chemical to, for example, a storage tank or directly to a point of use, for example a semiconductor processing tool. Advantageously, the cartridge 100 can easily be disconnected from and connected to the chemical source conduit and the product conduit to replace the spent purification material 105, to replace cartridge 100, or for other maintenance purposes.

The cartridge 100 is preferably coaxially positioned with respect to the chemical source conduit and the product conduit. Such coaxial alignment typically imparts flow characteristics to the flow of chemical therethrough which are effective for increasing the purity level of the flow of the chemical therethrough. In a preferred embodiment, the diameter of the chemical source conduit is substantially equal to that of the inlet 102 of the cartridge 100. The diameter of the product conduit is preferably substantially equal to that of the outlet 106.

With reference again to FIG. 1A, the cartridge 100 typically includes a first end member 108 that can be attached to the inlet 102. A second end member 110 can be attached to the outlet 106. As will be described below, the first and second end members 108 and 110 can maintain the purification material 105 in the conduit 104. The first end member 108 can be connected to receive the flow of the chemical to be purified and provide the flow to the conduit 104, and the second end member 110 can be connected to accommodate the flow of the purified chemical flowing out of the cartridge 100.

The end members 108 and 110 typically engage the inlet 102 and the outlet 106 of the conduit 104, respectively, to form liquid-tight seals therebetween. For example, the inlet 102 and outlet 106 can comprise flanges 140 and 142, respectively, into which the ends 144 and 146 of the end members 108 and 110 can be inserted, respectively.

The end members 108 and 110 can then be fastened to the conduit 104. For example, a first threaded portion 116 disposed on the first end member 108 can engage a second threaded portion 118 disposed on the inner surface of a first ring member 124. The first ring member 124 can be slideably and coaxially disposed about the conduit 104. The flange 140 of the inlet 102 can prevent the first ring member 124 from disengaging the conduit 104.

A third threaded portion 120 disposed on the second end member 110 can engage a fourth threaded portion 122 disposed on the inner surface of a second ring member 126. The second ring member 126 can be slideably and coaxially disposed about the conduit 104. The flange 142 of the outlet 106 can prevent the second ring member 126 from disengaging the conduit 104. Threaded portions that can be used include, for example, Flaretek and Purebond threaded fittings, and more preferably, 0.75 inch (1.91 cm) or 1 inch (2.54 cm) Flaretek and Purebond threaded fittings. Flaretek fittings are available from Fluoroware. Purebond fittings are available from Fluoroware and George Fisher.

The first and second end members 108 and 110 can optionally include first and second screens 112 and 114. The screens 112 and 114 can retain the purification material 105 inside the conduit 104 while allowing the flow of the chemical to pass therethrough. The screens 112 and 114 can be formed of a material that is suitable for contacting the chemical to be purified such as, for example, high-density polyethylene. The end members 108 and 110 can be detached from the conduit 104, thereby providing access to the interior of the conduit 104 for various maintenance purposes, such as for replacing the purification material 105 and/or for cleaning the interior surface of the conduit 104.

Referring to FIG. 1B, which is an exploded view of the first end member 108, the screen 112 is typically disposed between first and second flanged portions 128 and 130. The first and second flanged portions 128 and 130 preferably engage to form a liquid-tight seal therebetween. The first and second flanged portions 128 and 130 can then be fastened together, for example, by engaging a fifth threaded portion 132 disposed on the first end member 108 with a sixth threaded portion 134 disposed on the inner surface of a third ring member 136. The third ring member 136 can be slideably and coaxially disposed about the first end member 108. Flaretek and Purebond fittings may be used to fasten the flanged portions 128 and 130 together. By disengaging the first and second flanged portions 128 and 130, the screen 112 can be removed for various purposes such as, for example, replacing or cleaning the screen 112. The second end member 110 can have the same features as the first end member 108.

In an alternative embodiment, the screen 112 can be permanently positioned in the first end member 108. For example, referring to FIG. 1C, which is an exploded view of an alternative embodiment of the first end member 108, a commercially-available fitting, such as a Flaretek Union fitting, can be modified by milling the inner surface of an end of the fitting, thereby forming a milled end 150 of the first end member 108. A screen 112 can be positioned between the milled end 150 and an annular cap 152 and the annular cap 152 can be inserted into the milled end 150, thereby holding the screen 112 in place by friction fit, adhesive or other means. The screen 112 is preferably permanently positioned in the first end member 108 in this embodiment.

According to one aspect of the present invention, a detachable fitting for connection in a fluid transport line is provided. For example, according to one aspect of the present invention, the fitting can be an end member 108 and 110 described above. The fitting can easily be detached from the line, for example, to replace the fitting, to replace a device disposed in the fitting, or for other maintenance purposes. The fitting includes a conduit through which a flow of fluid may pass. The fitting can be connected to and disconnected from a fluid-providing line and a fluid-removing line, preferably by using a connection device such as, for example, threading disposed on the outer surface of the conduit of the fitting.

The fitting includes a device which engages the flow of fluid passing through the fitting. For example, the device can include a screen, a membrane or a filter. The device is preferably removable from the conduit of the fitting.

The fitting is not limited to use in liquid purification systems. For example, the fitting can be used in any system which transports fluid and uses one of the devices described above. In a preferred embodiment, the fitting can include a filter and can be installed upstream from a pump. The fitting can also be used in a transport line that accommodates a gas flow.

Advantageously, the fitting and/or the device disposed therein can periodically be cleaned and/or replaced. For example, filters and membranes typically require periodic cleaning and/or replacement for efficient operation. The fitting is formed of a material that is compatible with the fluid that passes therethrough. Preferably, the fitting is formed of polytetrafluoro-ethylene, perfluoroalkoxy, polypropylene, polyvinyl difluoride or TEFLON®. Alternatively, the fitting can be formed of a metal.

The cartridge 100 can be formed of a material which is suitable for accommodating the chemical to be purified and the purification material 105. The cartridge 100 is preferably made of a flexible material that can expand when subjected to high pressure conditions. For example, according to a preferred embodiment, the cartridge 100 can withstand a pressure of at least about 110 psig without bursting, more preferably at least about 700 psig. The ability of the cartridge 100 to resist bursting will at least additionally depend on the wall thickness of the cartridge 100. Preferably, the cartridge 100 can be formed of a material such as, for example, perfluoroalkoxy (PFA), TEFLON® or the combination thereof, more preferably TEFLON®. These materials are generally more flexible than materials typically used in current chemical purification systems, such as, for example, polypropylene, polyvinylidene (PVDF) or the combination thereof. Alternatively, the cartridge 100 can be made of the more rigid materials set forth above.

The cartridge 100 is preferably operated under single-pass conditions, i.e., the flow of the chemical to be purified is preferably passed through the cartridge 100 only once. In an alternative embodiment of the present invention, part of or the entire flow of the purified chemical removed from the outlet 106 of the cartridge 100 can be introduced to the inlet 102 of the cartridge 100 for further purification.

The cartridge 100 can be arranged horizontally which provides more options for where the cartridge 100 can be installed. Alternatively, the cartridge 100 can be arranged vertically or at an angle. In this alternative embodiment, the cartridge 100 is preferably positioned such that the chemical flows in an upward direction.

In a preferred embodiment, the cartridge 100 is used to purify a hydrogen peroxide solution. In such a case, the cartridge can contain one or more types of purification material. For example, a first type of purification material can be used which decreases the amount of an anionic contaminant, a second type can be used which decreases the amount of a cationic contaminant, and/or a third type can be used which decreases the amount of an organic contaminant, in the chemical to be purified. As stated above, if multiple types of purification materials are used, they can be mixed or separately maintained within the cartridge 100.

For reducing the presence of anionic contaminants in a hydrogen peroxide solution, the purification material preferably includes an anionic exchange resin such as, for example, DOWEX MONOSPHERE A550 UPN (polystyrene - DVB gel, quaternary ammonium, 1.0 eq. OH^{—}/l ) nuclear grade, available from Dow, or AMBERLITE IRA 958, available from Rohm and Haas (polyacrylic-DVB macroporous, quaternary ammonium 0.8 eq. Cl^{—}/l). Other anionic resins that are known in the art can be used.

For reducing the amount of cationic contaminants in a hydrogen peroxide solution, the purification material preferably includes a cationic exchange resin, such as, for example, DOWEX MONOSPHERE C650 UPN (polystyrene-DVB gel, sulfonic, 1.9 eq. H^{—}/l), available from Dow, or IRA 963 available from Rohm and Haas. Other cationic exchange resins that are known in the art can be used.

The cationic and/or anionic exchange resins that can be used in the cartridge 100 are preferably preconditioned prior to use. For example, the anionic exchange resin is preferably preconditioned by initially loading the resin with bicarbonate ions. Bicarbonate preconditioning is described in, for example, U.S. Pat. Nos. 3,294,488 and 3,305,314, the entire contents of which documents are hereby incorporated by reference. In general, bicarbonate preconditioning is preferred because other anions such as, for example, hydroxyl (OH^{—}) and chloride (Cl^{—}) ions, can catalyze the decomposition of hydrogen peroxide. The bicarbonate preconditioning step is preferably achieved by using a concentrated NH₄HCO₃ solution. Alternatives to NH₄HCO₃ can include, for example, an alkali bicarbonate, which typically requires removal of the alkali metal ions, or CO₂, the use of which is described in copending Application No.______ , Attorney Docket No. 016499-806, filed on even date herewith.

The cationic exchange resin is preferably preconditioned with an acid. For example, the cationic exchange resin can be preconditioned by contacting it with sulfuric acid, preferably a 10% molar solution of sulfuric acid.

An anionic/cationic resin mixture can optionally be used in place of or in addition to the anionic and/or cationic exchange resins. When a resin mixture is used in addition to the unmixed anionic and/or cationic exchange resins, the resin mixture is preferably disposed downstream from the unmixed anionic and/or cationic exchange resins.

A purification material for removing organic contaminants from the chemical to be purified can optionally be employed. Suitable materials for removing organic contaminants include, for example, AMBERLITE XAD-4 and AMBERSORB 563, available from Rohm and Haas. Other organic contaminant removal resins that are known in the art can be used.

The optional organic contaminant removal resin is preferably preconditioned. Preconditioning the resin typically reduces the content of metal impurities in the resin. Preferable techniques for preconditioning the organic contaminant removal resin are described in copending Application No.______ , Attorney Docket No. 016499-526, and Application No.______ , Attorney Docket No. 016499-650, filed on even date herewith, the entire contents of which applications are incorporated herein by reference.

For example, to precondition the organic contaminant removal resin, the resin can be rinsed with deionized water, preferably for from about 0.5 to 5 hours. The resin can then be contacted with an acid solution, preferably for from about 3 to 8 hours. The acid solution is typically an aqueous solution of a strong acid such as, for example, hydrochloric acid, nitric acid or sulfuric acid. The acid-treated resin can then be rinsed with deionized water.

Additionally or alternatively, the resin can be rinsed with deionized water to remove various contaminants therefrom. Some contaminants are not completely removable by the deionized water such as, for example, chloride, boron, calcium, iron, magnesium, zinc, potassium, silicon and sodium. The presence of such contaminants can be reduced by contacting the resin with an effective amount of a preconditioning hydrogen peroxide solution. Advantageously, the preconditioning hydrogen peroxide solution can be conducted for at least 12 bed volumes (BV), with a hydrogen peroxide solution flow rate preferably of 0.1 to 0.6 BV/min.

The cartridge 100 of the present invention preferably reduces the contact time between the flow of the chemical and the purification material 105. Factors which contribute to this reduced contact time include, for example, the amount of the purification material 105 that is disposed in the conduit 104, the flow rate of the chemical through the conduit 104 and/or the flow characteristics of the flow of the chemical through the conduit 104. Preferably, the contact time between the flow of the chemical and the purification material 105 is sufficiently long to allow the chemical to be purified.

In the case of hydrogen peroxide purification, the reduced contact time between the hydrogen peroxide solution and the purification material 105 typically decreases the decomposition of the hydrogen peroxide solution, thereby decreasing the amount of oxygen gas produced therefrom. Also, the reduced contact time can decrease the amount of ionic contaminants such as, for example, sulfates and/or chlorides, that are typically released from the purification material 105 during periods of prolonged contact.

The flow rate of the chemical to be purified in the cartridge 100 should be set such that the desired flow characteristics and purification levels can be achieved. A typical flow rate is from about 0.05 to about 20 liters per minute (lpm), preferably from about 2 to about 5 lpm, more preferably about 3 lpm. This flow rate is preferably for a cartridge having a diameter of 1 inch (2.54 cm) and a length of 25 inches (68.5 cm).

The flow rate through the cartridge 100 preferably is maximized. While different flow characteristics may be desirable for different applications, a flow which is effective for reducing the contact time between the hydrogen peroxide solution and the purification material 105 is typically preferred for the purification of a hydrogen peroxide solution. Such a flow can provide several advantages including, for example, extending the lifetime of the purification material 105, and/or reducing the amount of time required for the purified chemical to meet purity specifications during start up.

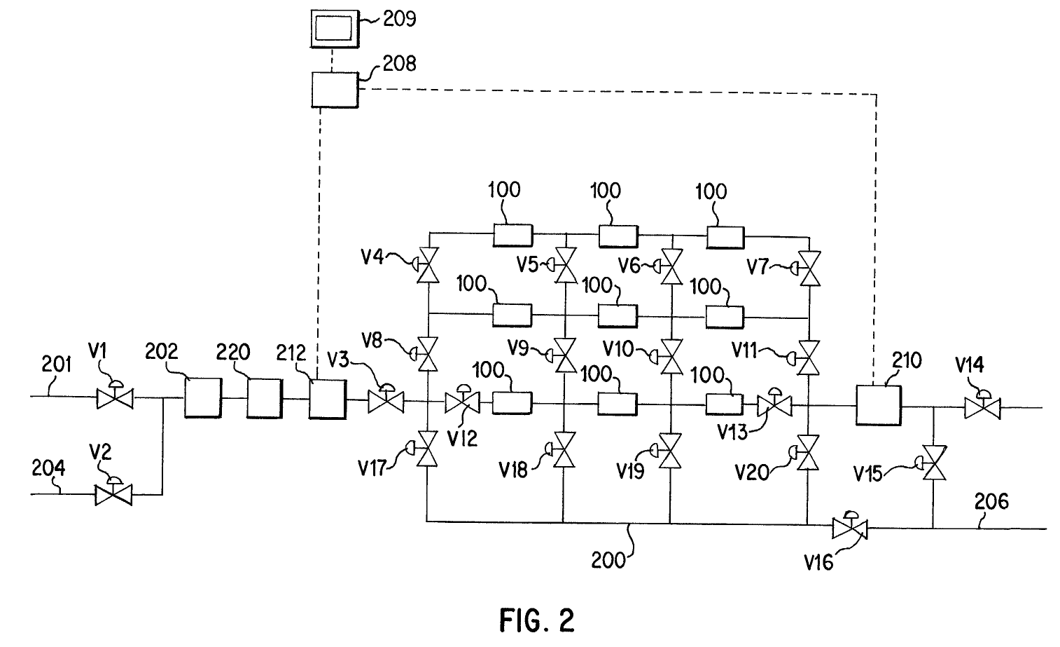

Referring to FIG. 2, according to another exemplary aspect of the present invention, an apparatus 200 for purifying a liquid chemical is provided. The apparatus 200 includes one or more of the cartridges 100 described above. For example, a plurality of the cartridges 100 can be employed, wherein the cartridges 100 are connected in series and/or in parallel. In a preferred embodiment, a plurality of cartridges 100 are connected in parallel.

More preferably, the apparatus 200 includes a plurality of groups of the cartridges 100, wherein each group includes at least two of the cartridges 100 connected in series. The plurality of groups of the cartridges 100 are preferably connected in parallel. The plurality of groups of the cartridges 100 can be arranged such that the flow of the chemical to be purified from the main inlet 201 is equally divided among the groups of the cartridges 100. The number of groups of the cartridges 100 depends, for example, on the desired flow rate of the purified chemical. By adjusting the number of groups of the cartridges 100 in the apparatus 200, the apparatus 200 can provide an amount of purified chemical comparable to that typically provided by current chemical purification systems.

In the case of hydrogen peroxide purification, each group of the cartridges 100 preferably includes three cartridges 100 connected in series. The first cartridge in the series preferably contains an organic contaminant removal resin to decrease the amount of organic contaminants in the chemical to be purified. The second and third cartridges preferably are arranged downstream from the first cartridge and preferably contain an anionic exchange resin followed by a cationic exchange resin, or a cationic exchange resin followed by an anionic exchange resin. As described above, a single cartridge can optionally contain two or more of the purification materials. For example, a cartridge containing a mixture of anionic and cationic exchange resins can be arranged downstream from the cartridge containing the organic contaminant removal resin. The cartridge containing the organic contaminant removal resin can be eliminated when the hydrogen peroxide solution to be purified has a suitably low organic contaminant level.

Use of a plurality of groups of the cartridges 100 arranged in parallel allows for continuous purification. For example, a group of the cartridges 100 can be replaced without stopping flow to another group of the cartridges 100 arranged in parallel thereto. Maintaining an uninterrupted liquid chemical flow during cartridge replacement can be accomplished, for example, through manipulating valves V4, V7, V8, V11, V12 and/or V13. According to an exemplary embodiment, to replace the uppermost group of cartridges 100 in FIG. 2, normally opened valves V4 and V7 can be closed. Control devices that are known in the art can be used to facilitate the manipulation of the valves in the apparatus 200.

The apparatus 200 can include normally opened valves V1 and V3 which allow the chemical to be purified to flow into the apparatus 200 via the main inlet 201. At least one pump 220 can increase the pressure of the chemical to be purified that flows into the apparatus 200. The pump 220 can be, for example, a diaphragm pump such as the Yamada DP 20 diaphragm pump. A typical operating pressure in the apparatus 200 is from about 20 to about 70 psig, preferably about 35 psig.

The temperature of the chemical in the apparatus 200 will typically depend on the particular chemical. An optional heat exchanger 202 can be connected to heat or cool the incoming flow of the chemical to be purified. A typical operating temperature within the apparatus 200 is from about 20 to about 30° C., preferably about 25° C.

Normally opened valve V14 permits the purified chemical to be removed from the apparatus 200, for example, to be introduced to a storage container or directly to a point of use.

The apparatus 200 can optionally include a water inlet 204 and a water outlet 206 for passing a flow of water, preferably deionized water, through the apparatus 200. For example, water can be passed through the apparatus 200 for cleaning purposes. Valves V2 and V15, which are typically in the closed position, can be opened to introduce a flow of water to the apparatus 200 and to remove the flow therefrom, respectively. Normally opened valves V1 and V14 can be closed to prevent water from flowing into the source and/or product streams. Optional, normally-closed valves V5, V6, V9 and V10 can be opened when water is introduced into the apparatus 200.

The apparatus 200 can also include a controller 208 and a mass flow controller 212 for controlling the flow rate of the chemical to be purified into the apparatus 200. The controller 208 can be, for example, a programmable logic controller. A concentration analyzer 210 can be connected to measure the concentration of impurities present in the flow of the purified chemical after it has passed through the plurality of the cartridges 100. The controller 208 can manipulate the mass flow controller 212 to control the flow rate of the chemical based on the concentration of impurities in the purified chemical measured by the concentration analyzer 210. For example, the presence of certain ions in the product stream can be reduced by adjusting the flow rate of the chemical. A display 209 can provide the user with various information regarding the status of the apparatus 200.

Safety features such as safety interlocks and safety valves are typically not required in the apparatus 200 because the plurality of the cartridges 100 can withstand high pressures and temperatures without bursting. Costs of implementing and maintaining such features, which are typically used in conventional columns, can thereby be avoided.

Alternatively, the apparatus 200 can optionally include pressure valves V17, V18, V19 and/or V20 which open to relieve pressure in the apparatus 200, for example, when the pressure in the apparatus 200 reaches a first predetermined value. The first predetermined value can be based on several factors including, for example, the number of cartridges 100 in the apparatus 200, the type of material the cartridges 100 are made of and/or the type of chemical being purified. For example, the first predetermined value can b set at about 100 psig. Typically, the first predetermined value is lower than the pressure at which the cartridge 100 is expected to burst.

In the event of overpressurization inside the apparatus 200, i.e., when the first predetermined value is reached, the pressure valves V17, V18, V19 and/or V20 can be opened until the pressure returns to a second predetermined value, at which point the valves V17, V18, V19 and/or V20 can be closed. The valves V17, V18, V19 and/or V20 preferably automatically open when the first predetermined value is reached. The second predetermined value can be the normal operating pressure of the apparatus 200, such as, for example, 35 psig. The chemical that is removed during the depressurization of the apparatus 200 can be purged by opening normally closed valve V16.

The apparatus 200 can be housed in an enclosure that provides convenient access for the periodic replacement of the cartridges 100. The enclosure is preferably formed of a material compatible with the chemicals being treated, in the event of leakage.

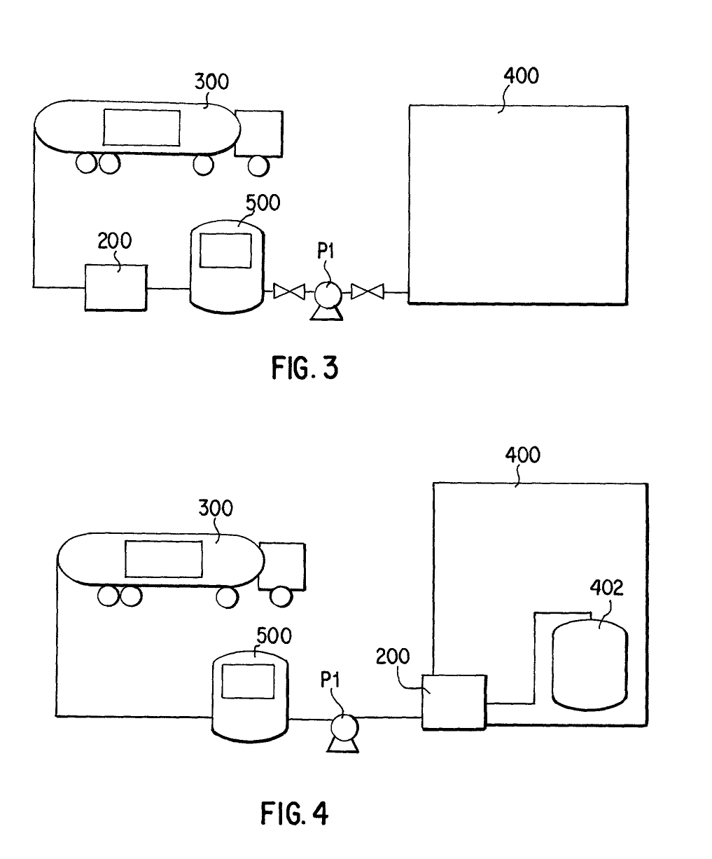

The apparatus 200 of the present invention can be located on-site in a facility, for example, a semiconductor fabrication facility, or proximate to the facility. For example, referring to FIG. 3, the apparatus 200 can be located outside a facility 400 in which the purified chemical is used. The apparatus 200 can be connected to receive the chemical to be purified from a mobile source 300 such as, for example, a tube trailer. The apparatus 200 can provide the purified chemical to a storage tank 500, and the purified chemical can then be transported using pump P1 to the facility 400. In this example, the flow rate of the chemical into the apparatus 200 is typically relatively high to quickly unload the chemical from the mobile source 300.

Referring to FIG. 4, according to another exemplary embodiment, the chemical can be unloaded from a mobile source 300 to a storage tank 500. The apparatus 200, which is located within the facility 400, can be connected to receive the chemical from the storage tank 500 and to pass the purified chemical to a day tank 402.

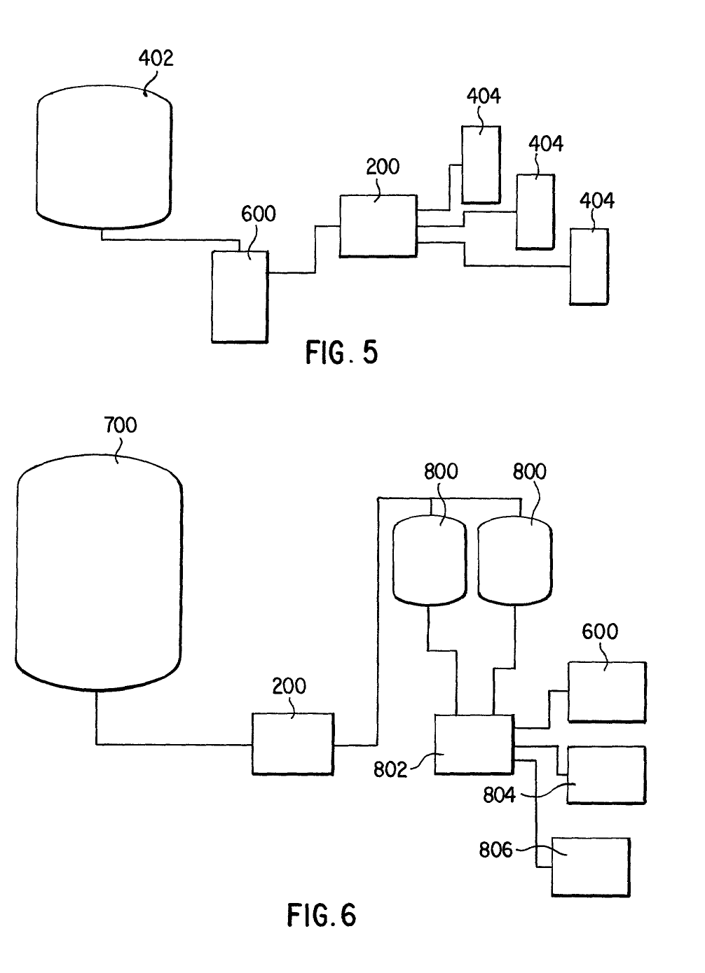

Referring to FIG. 5, according to another exemplary embodiment, the apparatus 200 can be connected to receive the chemical from a CDU 600 which receives the chemical from a day tank 402. The apparatus 200 can then send the purified chemical to various points of use 404 such as, for example, one or more semiconductor processing tools.

Referring to FIG. 6, according to a further exemplary embodiment, the apparatus 200 can be connected to receive the chemical from a bulk storage tank 700. The apparatus 200 can provide the purified chemical to a plurality of intermediate storage tanks 800. The purified product can then be passed to a quality control station 802, wherefrom the product can be distributed to various facilities such as, for example, a CDU 600, a mobile chemical vessel (MCV) fill 804 or a drum fill 806. The drum is typically a cylindrical container, preferably having a volume of about 55 gallons.

The apparatus 200 of the present invention can be relatively compact in size compared to current chemical purification systems. As a result, the present apparatus 200 can be placed in areas which typically cannot accommodate a chemical purification system. For example, the apparatus 200 can be attached to a wall of a building, similar to a valve manifold box (VMB), or be attached to a CDU, similar to a filter assembly. The apparatus 200 can also be installed on a chemical delivery vehicle.

In order to further illustrate the present invention and the advantages thereof, the following specific examples are given, it being understood that the examples are intended only as illustrative and are in no way limiting.

### EXAMPLES

### EXAMPLE 1

### PURIFICATION OF A HYDROGEN PEROXIDE SOLUTION

A cartridge as described above and as illustrated in FIG. 1A was used to purify a flow of a hydrogen peroxide solution. The cartridge was formed of PFA. The inside diameter of the cartridge was 0.87 inch (2.22 cm), and the outside diameter was 1 inch (2.54 cm). The length of the packed section was 25 inches (63.5 cm). The cross-sectional area of the conduit was 3.88 cm² and the resin bed volume (BV) was 246 cc. The purification material present in the cartridge was a mixture of DOWEX MONOSPHERE 550 LC NG OH anion resin and DOWEX MONOSPHERE C-650 NG H cation resin H form, available from Dow.

A flow of a hydrogen peroxide solution was passed through the cartridge at a constant flow rate of 1.6 liters per minute (6.5 BV per minute). The pressure drop across the cartridge was 2.5 bar (250 kPa).

The concentrations (in ppb) of various contaminants in the hydrogen peroxide solution were measured after 0 (0 BV), 10 (64 BV), 30 (192 BV), 60 (384 BV), 90 (576 BV) and 120 (768 BV) minutes of passing the flow of the hydrogen peroxide solution through the cartridge. The results are shown in Table 1.

As can be seen from Table 1, the cartridge provided a purified hydrogen peroxide solution with significantly reduced levels of many contaminants at each measured interval, particularly at the 120 minute interval. For example, the amount of chloride ions was conspicuously reduced from 26 ppb to 7 ppb at 120 minutes. Also, the amount of sulfate ions was reduced from 34 ppb to 2 ppb at 120 minutes. In comparison, a purification column having an inside diameter of 4 inches and a resin column length of 25 inches provided a hydrogen peroxide solution having an optimized nitrate concentration of 14 ppb and an optimized sulfate concentration of 16 ppb.

TABLE 1

| | 0 | 10 | 30 | 60 | 90 | 120 |
|---|---|---|---|---|---|---|
| Bromide | <0.5 | <0.5 | <0.5 | <0.5 | <0.5 | <0.5 |
| Chloride | 26.0 | <0.5 | 16.0 | 3.0 | 4.0 | 7.0 |
| Nitrate | 9.0 | 8.0 | 9.0 | 10.0 | 9.0 | 8.0 |
| Nitrite | 1.0 | 13.0 | <0.5 | 2.0 | 2.0 | 2.0 |
| Phosphate | <1.0 | 8.0 | <1.0 | <1.0 | <1.0 | <1.0 |
| Sulfate | 35.0 | 24.0 | 17.0 | 3.0 | 2.0 | 2.0 |
| Calcium | 0.260 | 0.010 | 0.010 | <0.010 | <0.010 | <0.010 |
| Iron | <0.050 | <0.050 | <0.050 | <0.050 | <0.050 | <0.050 |
| Potassium | 0.020 | <0.010 | <0.010 | <0.010 | <0.010 | <0.010 |
| Sodium | 0.490 | 0.050 | 0.030 | 0.020 | 0.030 | 0.030 |
| Aluminum | 0.190 | 0.030 | <0.010 | <0.010 | <0.010 | 0.010 |
| Antimony | <0.010 | <0.010 | <0.010 | <0.010 | <0.010 | <0.010 |
| Arsenic | <0.010 | <0.010 | <0.010 | <0.010 | <0.010 | <0.010 |
| Barium | 0.080 | 0.020 | <0.010 | <0.010 | <0.010 | <0.010 |
| Beryllium | <0.010 | <0.010 | <0.010 | <0.010 | <0.010 | <0.010 |
| Bismuth | <0.010 | <0.010 | <0.010 | <0.010 | <0.010 | <0.010 |
| Boron | 0.890 | <0.010 | 0.010 | <0.010 | <0.010 | <0.010 |
| Cadmium | <0.010 | <0.010 | <0.010 | <0.010 | <0.010 | <0.010 |
| Chromium | <0.120 | <1.720 | <0.470 | <0.230 | <0.230 | <0.190 |
| Cobalt | <0.010 | <0.010 | <0.010 | <0.010 | <0.010 | <0.010 |
| Copper | 0.020 | <0.010 | <0.010 | <0.010 | <0.010 | <0.010 |
| Gallium | <0.010 | <0.010 | <0.010 | <0.010 | <0.010 | <0.010 |
| Germanium | <0.010 | <0.010 | <0.010 | <0.010 | <0.010 | <0.010 |
| Gold | <0.010 | <0.010 | <0.010 | <0.010 | <0.010 | <0.010 |
| Indium | <0.010 | <0.010 | <0.010 | <0.010 | <0.010 | <0.010 |
| Lanthanum | <0.010 | <0.010 | <0.010 | <0.010 | <0.010 | <0.010 |
| Lead | <0.010 | <0.010 | <0.010 | <0.010 | <0.010 | <0.010 |
| Lithium | <0.010 | <0.010 | <0.010 | <0.010 | <0.010 | <0.010 |
| Magnesium | 0.280 | 0.070 | <0.010 | <0.010 | <0.010 | <0.010 |
| Manganese | <0.010 | <0.010 | <0.010 | <0.010 | <0.010 | <0.010 |
| Molybdenum | 0.010 | 0.450 | <0.010 | <0.010 | <0.010 | <0.010 |
| Nickel | 0.050 | 0.030 | <0.010 | <0.010 | <0.010 | <0.010 |
| Niobium | <0.010 | <0.010 | <0.010 | <0.010 | <0.010 | <0.010 |
| Palladium | <0.010 | <0.010 | <0.010 | <0.010 | <0.010 | <0.010 |
| Platinum | <0.010 | <0.010 | <0.010 | <0.010 | <0.010 | <0.010 |
| Silver | <0.010 | <0.010 | <0.010 | <0.010 | <0.010 | <0.010 |
| Strontium | <0.010 | <0.010 | <0.010 | <0.010 | <0.010 | <0.010 |
| Tantalum | <0.070 | <0.040 | <0.150 | <0.020 | <0.010 | <0.030 |
| Thallium | <0.010 | <0.010 | <0.010 | <0.010 | <0.010 | <0.010 |
| Tin | <0.010 | <0.010 | <0.010 | <0.010 | <0.010 | <0.010 |
| Titanium | 0.050 | 0.020 | 0.020 | <0.010 | 0.010 | 0.030 |
| Tungsten | <0.010 | <0.010 | <0.010 | <0.010 | <0.010 | 0.010 |
| Vanadium | <0.010 | <0.010 | <0.010 | <0.010 | <0.010 | <0.010 |
| Zinc | 0.270 | 0.090 | 0.020 | <0.010 | <0.010 | 0.020 |
| Zirconium | <0.010 | <0.010 | <0.010 | <0.010 | <0.010 | <0.010 |

The measured useable lifetime of the purification material was at least about 18 hours (7000 BV). Referring to Table 2, hydrogen peroxide was further introduced to the cartridge and the concentrations of various cations were measured up to 13628 BV.

TABLE 2

| BV | Fe | K | Na | Ca | B | Mg | Ni | Zn |
|---|---|---|---|---|---|---|---|---|
| 960 | <0.050 | <0.010 | 0.06 | 0.01 | 0.01 | 0.07 | 0.01 | 0.01 |
| 1008 | <0.050 | <0.010 | 0.03 | 0.01 | 0.01 | 0.01 | 0.01 | 0.01 |
| 1248 | <0.050 | <0.010 | 0.03 | 0.01 | 0.01 | 0.01 | 0.01 | 0.01 |
| 1488 | <0.050 | <0.010 | 0.04 | 0.01 | 0.01 | 0.01 | 0.01 | 0.01 |
| 1728 | <0.050 | <0.010 | 0.04 | 0.01 | 0.01 | 0.01 | 0.01 | 0.01 |
| 1968 | <0.050 | <0.010 | 0.04 | 0.03 | 0.01 | 0.01 | 0.01 | 0.02 |
| 4788 | <0.050 | <0.010 | 0.03 | 0.01 | 0.01 | 0.01 | 0.01 | 0.03 |
| 4908 | <0.050 | <0.010 | 0.02 | 0.01 | 0.01 | 0.01 | 0.01 | 0.1 |
| 5148 | <0.050 | <0.010 | 0.01 | 0.01 | 0.01 | 0.01 | 0.01 | 0.1 |
| 5388 | <0.050 | <0.010 | 0.01 | 0.01 | 0.01 | 0.01 | 0.01 | 0.1 |
| 5628 | <0.050 | <0.010 | 0.02 | 0.01 | 0.01 | 0.01 | 0.01 | 0.02 |
| 6028 | <0.050 | <0.010 | 0.02 | 0.01 | 0.02 | 0.06 | 0.01 | 0.01 |
| 6428 | <0.050 | <0.010 | 0.02 | 0.01 | 0.01 | 0.08 | 0.01 | 0.01 |
| 6828 | <0.050 | <0.010 | 0.02 | 0.01 | 0.01 | 0.13 | 0.01 | 0.01 |
| 7228 | <0.050 | <0.010 | 0.02 | 0.01 | 0.05 | 0.01 | 0.01 | 0.01 |
| 7628 | <0.050 | <0.010 | 0.02 | 0.01 | 0.04 | 0.01 | 0.01 | 0.01 |
| 8028 | <0.050 | <0.010 | 0.01 | 0.01 | 0.06 | 0.01 | 0.01 | 0.01 |
| 8428 | <0.050 | <0.010 | 0.02 | 0.02 | 0.04 | 0.01 | 0.03 | 0.02 |
| 8828 | <0.050 | <0.010 | 0.02 | 0.01 | 0.04 | 0.01 | 0.02 | 0.03 |
| 9228 | <0.050 | <0.010 | 0.03 | 0.01 | 0.05 | 0.01 | 0.01 | 0.02 |
| 9628 | <0.050 | <0.010 | 0.01 | 0.02 | 0.05 | 0.01 | 0.01 | 0.03 |
| 10028 | <0.050 | <0.010 | 0.04 | 0.01 | 0.06 | 0.01 | 0.02 | 0.02 |
| 10428 | <0.050 | <0.010 | 0.03 | 0.01 | 0.1 | 0.01 | 0.02 | 0.02 |
| 10828 | <0.050 | <0.010 | 0.03 | 0.01 | 0.09 | 0.01 | 0.02 | 0.02 |
| 11228 | <0.050 | <0.010 | 0.02 | 0.01 | 0.14 | 0.01 | 0.01 | 0.01 |
| 11628 | <0.050 | <0.010 | 0.02 | 0.01 | 0.12 | 0.01 | 0.01 | 0.01 |
| 12028 | <0.050 | <0.010 | 0.01 | 0.01 | 0.12 | 0.01 | 0.01 | 0.01 |
| 12428 | <0.050 | <0.010 | 0.02 | 0.01 | 0.09 | 0.01 | 0.01 | 0.01 |
| 12828 | <0.050 | <0.010 | 0.02 | 0.01 | 0.12 | 0.01 | 0.01 | 0.01 |
| 13228 | <0.050 | <0.010 | 0.02 | 0.01 | 0.11 | 0.01 | 0.02 | 0.01 |
| 13628 | <0.050 | <0.010 | 0.02 | 0.02 | 0.09 | 0.01 | 0.05 | 0.01 |

The purification material in the cartridge became no longer useable when a breakthrough of ionic contaminants was detected, for example, Boron, Aluminum and/or Nickel typically are the first ionic contaminants to increase in concentration.

### EXAMPLE 2

### EXERTING INTERNAL PRESSURE USING WATER

A cartridge made of PFA withstood a high internal pressure for several days without bursting. In this example, water was introduced to a PFA cartridge to determine the amount of pressure the cartridge could withstand. The cartridge did not burst until being subjected to a pressure of about 650 to about 700 psig. In addition, the breach of the cartridge did not release a large amount of liquid.

### EXAMPLE 3

### EXERTING INTERNAL PRESSURE USING A HYDROGEN PEROXIDE SOLUTION

A hydrogen peroxide solution was introduced to a PFA cartridge to determine the amount of pressure the cartridge could withstand. The cartridge withstood about 100 psig of pressure without bursting. In this example, oxygen gas formed from the decomposition of the hydrogen peroxide solution increased the internal pressure of the cartridge.

While the invention has been described in detail with reference to specific embodiments thereof, it will be apparent to one skilled in the art that various changes and modifications can be made, and equivalents employed without departing from the scope of the claims.

What is claimed is:

1. A cartridge for purifying a liquid chemical, comprising:
(a) a conduit connected to receive a flow of a chemical to be purified; and
(b) a packed section in the conduit comprising a purification material, wherein the ratio of the length of the packed section to the inside diameter of the conduit is from about 8:1 to about 200:1, and wherein the flow of the chemical to be purified contacts the purification material, thereby producing a flow of a purified chemical.

2. The cartridge according to claim 1, wherein the chemical to be purified comprises a chemical selected from the group consisting of a hydrogen peroxide solution, hydrofluoric acid, hydrochloric acid, acetic acid, ammonium hydroxide solution, water and combinations thereof.

3. The cartridge according to claim 2, wherein the chemical to be purified comprises the hydrogen peroxide solution, and wherein the purification material reduces the amount of a contaminant selected from the group consisting of an organic contaminant, a cationic contaminant, an anionic contaminant and combinations thereof, in the chemical to be purified upon contact therewith.

4. The cartridge according to claim 1, wherein the ratio of the length of the packed section to the inside diameter of the conduit is from about 15:1 to about 50:1.

5. The cartridge according to claim 4, wherein the ratio of the length of the packed section to the inside diameter of the conduit is about 25:1.

6. The cartridge according to claim 1, wherein the length of the packed section is from about 16 to about 50 inches.

7. The cartridge according to claim 6, wherein the length of the packed section is about 25 inches.

8. The cartridge according to claim 1, wherein the inside diameter is from about 0.25 to about 2 inches.

9. The cartridge according to claim 8, wherein the inside diameter of the conduit is about 1 inch.

10. The cartridge according to claim 1, wherein the cartridge is formed from a material selected from the group consisting of PFA, TEFLON® and the combination thereof.

11. The cartridge according to claim 1, wherein the length of the packed section is shorter than the length of the conduit.

12. The cartridge according to claim 1, further comprising at least one screen for maintaining the purification material in the conduit.

13. The cartridge according to claim 1, wherein the conduit is connected to a fluid-providing line at one end thereof and a product line at another end thereof, wherein the diameters of the conduit, fluid-providing line and product line are equal.

14. The cartridge according to claim 1, wherein the conduit is connected to a fluid-providing line at one end thereof and a product line at another end thereof, wherein the conduit, the fluid-providing line and the product line are coaxially arranged.

15. A method for purifying a liquid chemical, comprising introducing the flow of the chemical to be purified to the cartridge of claim 1.

16. The method according to claim 15, wherein the flow rate of the chemical to be purified in the cartridge is from about 0.05 to about 20 liters per minute.

17. The method according to claim 16, wherein the flow rate of the chemical to be purified in the cartridge is from about 2 to about 5 liters per minute.

18. The method according to claim 15, wherein the chemical to be purified comprises a chemical selected from the group consisting of a hydrogen peroxide solution, hydrofluoric acid, hydrochloric acid, acetic acid, ammonium hydroxide solution, water and combinations thereof.

19. An apparatus for purifying a liquid chemical, comprising:
(a) a chemical source for providing a main flow of the chemical to be purified; and
(b) a plurality of the cartridges according to claim 1, wherein the plurality of the cartridges is connected to receive the main flow of the chemical to be purified.

20. The apparatus according to claim 19, wherein the apparatus comprises a part of a semiconductor manufacturing facility.

21. The apparatus according to claim 19, wherein the plurality of the cartridges comprises a plurality of groups of the cartridges connected in parallel, wherein each group of the cartridges comprises three cartridges connected in series.

22. The apparatus according to claim 21, wherein each group of the cartridges comprises a first cartridge comprising an organic contaminant-reducing purification material, a second cartridge comprising an anionic contaminant-reducing purification material, and a third cartridge comprising a cationic contaminant-reducing purification material.

23. The apparatus according to claim 19, wherein the chemical to be purified comprises a chemical selected from the group consisting of a hydrogen peroxide solution, hydrofluoric acid, hydrochloric acid, acetic acid, ammonium hydroxide solution, water and combinations thereof.

24. The apparatus according to claim 23, wherein the chemical to be purified comprises the hydrogen peroxide solution.

25. The apparatus according to claim 19, wherein for each cartridge, the ratio of the length of the packed section to the inside diameter of the conduit is from about 15:1 to about 50:1.

26. The apparatus according to claim 25, wherein for each cartridge, the ratio of the length of the packed section to the inside diameter of the conduit is about 25:1.

27. The apparatus according to claim 19, wherein the length of the packed section of each cartridge is from about 16 to about 50 inches.

28. The apparatus according to claim 27, wherein the length of the packed section of each cartridge is about 25 inches.

29. The apparatus according to claim 19, wherein the inside diameter of the conduit of each cartridge is from about 0.25 to about 2 inches.

30. The apparatus according to claim 29, wherein the inside diameter of the conduit of each cartridge is about 1 inch.

31. The apparatus according to claim 19, wherein each cartridge is formed from a material selected from the group consisting of PFA, TEFLON® and the combination thereof.

32. The apparatus according to claim 19, wherein for each cartridge, the length of the packed section is shorter than the length of the conduit.

33. The apparatus according to claim 19, wherein each cartridge further comprises at least one screen for maintaining the purification material in the conduit.

34. A method for purifying a liquid chemical, comprising introducing the main flow of the chemical to be purified to the plurality of the cartridges of the apparatus of claim 19.

35. The method according to claim 34, wherein the flow rate of the chemical to be purified in each cartridge of the apparatus is from about 0.05 to about 20 liters per minute.

36. The method according to claim 35, wherein the flow rate of the chemical to be purified in each cartridge of the apparatus is from about 2 to about 5 liters per minute.

37. The method according to claim 34, wherein the chemical to be purified comprises a chemical selected from the group consisting of a hydrogen peroxide solution, hydrofluoric acid, hydrochloric acid, acetic acid, ammonium hydroxide solution, water and combinations thereof.

38. A detachable fitting for connection to a fluid transport line, comprising:
(a) a conduit having an inlet end for receiving a flow of fluid from a fluid-providing line and an outlet end for introducing the flow of fluid to a fluid-receiving line;
(b) a first connection device arranged to removably connect the inlet end of the conduit to the fluid-providing line;
(c) a second connection device arranged to removably connect the outlet end of the conduit to the fluid-receiving line; and
(d) a device disposed inside the conduit, wherein the flow of fluid contacts the device.

39. The detachable fitting according to claim 38, wherein the conduit is formed of a material selected from the group consisting of PTFE, PFA, polypropylene, polyvinyl difluoride TEFLON and combinations thereof.

40. The detachable fitting according to claim 38, wherein the device disposed inside the conduit is selected from the group consisting of a screen, a membrane and a filter.

41. The detachable fitting according to claim 38, wherein the device is removable from the conduit.

42. The detachable fitting according to claim 38, wherein the fluid is a liquid.

43. The detachable fitting according to claim 38, wherein the inlet and outlet ends of the conduit are respectively inserted into flanged ends of the fluid-providing line and the fluid-receiving line.

44. The detachable fitting according to claim 38, wherein the first connection device comprises a threaded section arranged to removably connect the inlet end of the conduit to the fluid-providing line.

45. The detachable fitting according to claim 38, wherein the second connection device comprises a threaded section arranged to removably connect the outlet end of the conduit to the fluid-receiving line.
